(19) United States
(12) Patent Application Publication
(10) Pub. No.: US 2016/0048710 A1
(43) Pub. Date: Feb. 18, 2016

(54) LONG-RANGE UWB REMOTE POWERING CAPABILITY AT FCC REGULATED LIMIT USING MULTIPLE ANTENNAS

(71) Applicant: Lawrence Livermore National Security, LLC, Livermore, CA (US)

(72) Inventors: Faranak Nekoogar, San Ramon, CA (US); Farid U. Dowla, Castro Valley, CA (US); David M. Benzel, Gilmer, TX (US); Richard E. Twogood, San Diego, CA (US)

(73) Assignee: Lawrence Livermore National Security, LLC, Livermore, CA (US)

(21) Appl. No.: 14/331,057

(22) Filed: Jul. 14, 2014

Related U.S. Application Data
(60) Provisional application No. 61/845,695, filed on Jul. 12, 2013.

(51) Int. Cl. G06K 7/10; H04B 1/7163

(52) U.S. Cl. CPC G06K 7/10158; H04B 1/7163

(57) ABSTRACT

A method and apparatus for remote UWB powering of passive RFID tags, sensors, and other electronic devices at long ranges and still at FCC low emission power limits utilizes a distributed multi-transmitter system configured for spotforming. The UWB powering signal is different from the signal that is used for communication between the tag and its reader. By de-coupling the powering task from the communication task, one is able to increase the range of communication between the tag and the reader, as readers can be designed to have excellent receiver sensitivities, while powering range is increased by use of multiple “spot-forming” antennas over a large area.

### CROSS-REFERENCE TO RELATED APPLICATIONS

This application claims the benefit of U.S. Provisional Application No. 61/845,695, filed Jul. 12, 2013, and entitled, “Long-Range, UWB Remote Powering Capability at FCC Regulated Limit Using Multiple Antennas,” which is incorporated herein by this reference.

### STATEMENT REGARDING FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

1. Field of the Invention

The present invention relates generally to ultra-wideband (UWB) technology, and more particularly, to long range UWB powering of passive RFID tags, passive sensors, and other passive electronic devices.

2. Description of Related Art

Radio Frequency Identification (RFID) is an automatic identification technology that uses radio signals to identify and track objects. Although many types of short-range RFID systems are available for inventory management and tracking of high-value items, most fall short in critical areas: range of operation (commercially available passive RFID tags operate over very short ranges), power consumption (active tags require batteries), cost, size, and security.

Conventional RFID systems—like those used by automated toll systems—include a reader that is both a transmitter and a receiver, and target tags. The reader communicates with the tags using narrowband radio signals. The tags store a serial number and perhaps other data and are attached to an antenna that transmits identification information to the reader. Most active commercial systems have tags require an energy source, such as batteries, which are expensive, have a limited lifetime, and must be replaced periodically. Current commercial tags that are passive are highly range limited. Further, the narrowband signals that carry the identification data cannot penetrate some materials, including walls, dirt, or metal; most have short ranges (less than 2 meters); and they cannot operate in cluttered environments, such as warehouses full of metal shelving. Other commercially available RFID systems that use narrowband frequencies are vulnerable to interception and detection, making them unsuitable for most military and high security applications. In conventional RFID applications, the same narrow band radio-frequency (RF) signal is used for both powering-up and communication with the tag.

U.S. Pat. No. 8,188,841 to Dowla et al. discloses a method and apparatus for remote powering and detecting multiple UWB passive tags in an RFID system. The method and system utilize passive (i.e., non-battery-operated) Ultra-Wideband (UWB) powering configurations at relatively long ranges in detection friendly as well as harsh and cluttered environments. The system has a separate UWB powering transmitter and a radar interrogation unit.

Ultra-wideband (UWB) offers many advantages over narrowband. UWB operates by transmitting a sequence of very short pulses instead of a continuous wave. However, FCC regulations limit UWB transmissions at −41.3 dBm/MH, which allows for short range communications. The communications range for passive tags is limited mostly due to their forward link which is the powering link. To date there are no UWB passive tags with long range due to FCC limitations. The problem of UWB powering of RFID tags also applies to passive sensors and other passive electronic devices.

UWB “spotforming” can localize the energy transferred from multiple antenna arrays to a focal point of interest in both space and time. Spotforming is described in Dowla et al., “Spotforming with an Array of Ultra-Wideband Radio Transmitters,” Lawrence Livermore National Laboratory, UCRL-TR-202378, Feb. 17, 2004, which is herein incorporated by reference.

Accordingly it is advantageous to provide for long range powering of passive tags, sensors, and other devices from a long distance while still meeting the FCC regulations

### SUMMARY OF THE INVENTION

An aspect of the invention is an ultra-wideband (UWB) method of providing one or more passive electronic devices, remotely powering each device by providing a plurality of remotely located ultra-wideband transmitters, generating low duty cycle high-peak power ultra-wideband pulses from each transmitter, positioning multiple of the plurality of transmitters to transmit pulses to each device, the pulses from the multiple transmitters arriving at each device cumulatively combining to produce a power level to activate the device, and interrogating each activated device.

Another aspect of the invention is an ultra-wideband (UWB) remotely powered system, having one or more passive electronic devices, a plurality of remotely located ultra-wideband transmitters, each configured to generate low duty cycle high-peak power ultra-wideband pulses, multiple of the plurality of transmitters being positioned to transmit pulses to each device, the pulses from the multiple transmitters arriving at each device cumulatively combining to produce a power level to activate the device, and a reader positioned to interrogate each activated device.

### BRIEF DESCRIPTION OF THE DRAWINGS

The accompanying drawings, which are incorporated into and form a part of the disclosure, illustrate an embodiment of the invention and, together with the description, serve to explain the principles of the invention.

FIG. 1 is a general block diagram of an Ultra-Wideband (UWB) powering system of the present invention using a plurality of UWB powering transmitters.

FIGS. 2A and 2B are general block diagrams respectively a UWB powering transmitter and a passive remote UWB RFID tag that may be used in the present invention.

FIG. 3 illustrates UWB spotforming with an array of transmitters.

FIGS. 4A and 4B respectively illustrate power transfer efficiency of remote RFID tags using continuous wave (CW) signaling and UWB signaling of the present invention.

FIGS. 5A and 5B are graphs (amplitude vs. time) of a transmitted UWB pulse designed to power up the remote passive devices of the present invention, and the voltage signal available in a circuit at a distance of 15 m.

### DETAILED DESCRIPTION OF THE INVENTION

Referring now to the drawings, specific embodiments of the invention are shown. The detailed description of the specific embodiments, together with the general description of the invention, serves to explain the principles of the invention. All publications, patent applications, patents, and other references mentioned herein are incorporated by reference in their entirety. In case of conflict, the present specification, including definitions, will control.

### General Description

Ultra-wideband (UWB) communication systems in general, employ very narrow (pico-second to nano-second) radio frequency (RF) pulses to transmit and receive information. The short duration of such wideband pulses provides very wide bandwidth (in the range of GHz) with a low power spectral density (PSD). The low PSD enables UWB signals to share the RF spectrum with currently available radio services with minimal or no interference problems. Therefore, no expensive licensing of the spectrum is required by use of such UWB systems. However, FCC regulations limit UWB transmissions to −41.3 dBm/MH, which allows for short range communications.

To be more specific, because of the low power spectral density, UWB pulses reside below the noise floor of a typical narrowband receiver, therefore, they become undetectable from background noise in most cases and only the intended receiver is able to detect them. Hence, the UWB tags, as described herein, are not vulnerable to detection, interception, and jamming. Furthermore, due to their large bandwidth and frequency diversity, the utilized UWB pulses are less sensitive to multi-path effects than when using continuous wave (CW) signals and such UWB pulses can provide excellent spatial resolutions. The fine spatial resolution of often down to less than about a foot, more often down to about a cm, enables the radio frequency identification (RFID) applications of the present invention to be utilized in heavy metallic environments, such as highly metal and constricted corridors found in most inventory configured enclosures. In addition, the lower frequencies covered by the inherent large UWB bandwidth offers good penetration properties, which provides through the wall communications and overcomes common signal blockage problems. Moreover, the UWB configurations described herein have fewer components and can be manufactured in smaller form factors compared to typical narrowband communication systems.

As understood by those of ordinary skill in the art, conventional methods for remote powering use continuous wave (CW) radio frequency bursts or a magnetic field. These charging methods limit the range of commercially available tags. To lengthen their range, conventional tags must have an energy source, such as a battery; but batteries have a limited lifetime, and are expensive and large in size.

The present invention is a method and apparatus for remote UWB powering of passive RFID tags, sensors, and other electronic devices at long ranges and still at FCC low emission power limits utilizing a distributed multi-transmitter system configured for spotforming. Unlike conventional RFID applications in which the same narrowband radio-frequency (RF) signal is used for both powering-up and communication with the tag, in the present invention, the UWB powering signal is different from the signal that is used for communication between the tag and its reader. For example, once the sensor or tag is powered up with a distributed multi-antenna UWB system, the senor or tag can then respond with a different UWB (or even narrowband) signal to communicate with the reader. By de-coupling the powering task from the communication task, one is able to increase the range of communication between the tag and the reader, as readers can be designed to have excellent receiver sensitivities, while powering range is increased by use of multiple “spot-forming” antennas over a large area.

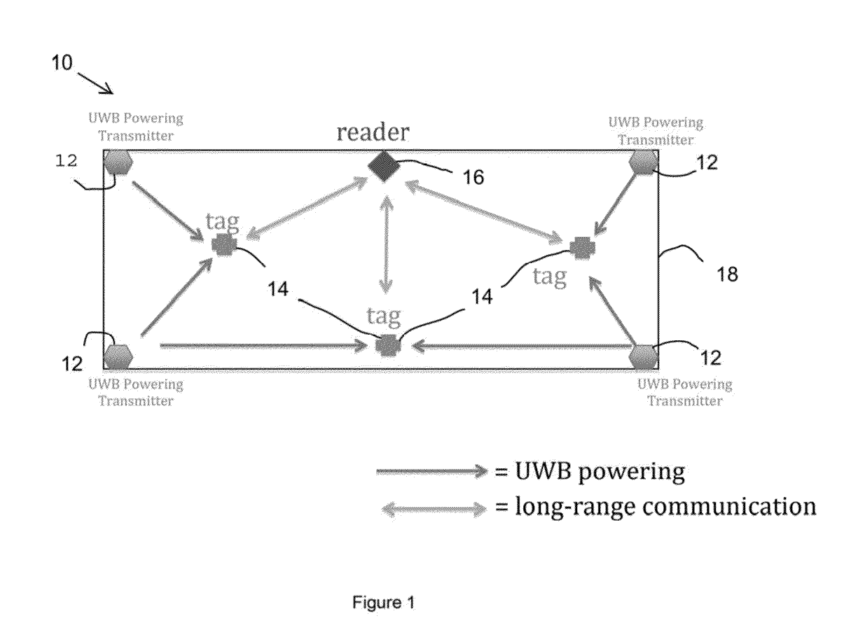

FIG. 1 show one possible configuration to achieve long-range communication by using a set of distributed UWB powering transmitters (or emitters). The UWB powered RFID system 10 of the invention includes a plurality of UWB powering transmitters 12. Each transmitter 12 may be an individual UWB transmitter or an array of UWB transmitters, as described further herein. System 10 also includes a plurality of passive RFID tags (or passive sensors or other passive electronic devices) 14. Multiple UWB powering transmitters (or transmitter arrays) 12 send UWB signals to each tag 14 to power (activate) the tags 14. The activated tags 14 communicate with a reader (interrogator) 16. In accordance with the invention, the power signals and communication signals are separate signals. The power signals are one way, from the transmitters 12 to the tags 14. The communications signals are two-way, between the tags 14 and the reader 16, i.e., the reader 16 can send interrogatories to the tags 14 and the tags 14 can reply to the reader 16. The system 10 may be disposed in a room or building or space 18. By de-coupling the powering transmitter signal from the reader communication signal one can achieve long-range passive tags or sensors for remote interrogation.

One significant advantage of using a set of distributed UWB powering transmitters is that it can meet the FCC requirements for UWB signal emissions. FCC regulations limits UWB transmissions at −41.3 dBm/MH which allows for short range communications. The communications range for passive tags is limited mostly due to their forward link which is powering link. This invention addresses this limitation using a set of distributed UWB transmitters and using a method of array “spot-forming.” This invention allows for long range powering of passive tags and any other sensors from a long distance while still meeting the FCC regulations.

The invention uses multiple UWB antennas to transmit from various locations to localized point in space and time to increase the received energy for powering passive RFID tags or passive sensors or other passive devices. By carefully designing the antenna geometry, e.g. by selecting the spacing between the elements of an antenna array, optimal powering of the devices can be achieved within FCC limits. The antennas can also be placed at different corners of a room focusing at passive tags or sensors. The impinging UWB pulses add their energy to provide the voltage necessary to overcome the diode drop and still leave enough voltage to operate at long ranges.

### UWB Spotforming for Remote Powering

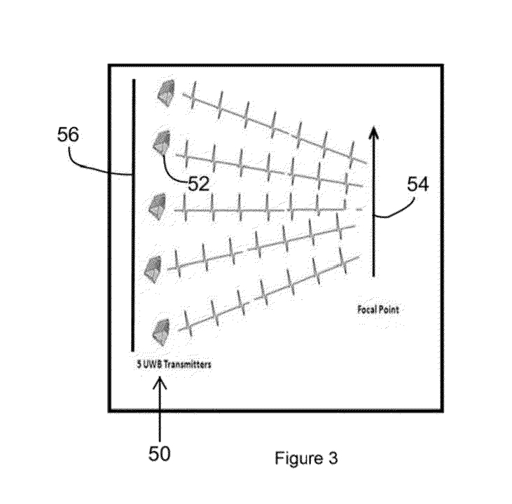

Ultra-wideband signals can be focused in space and time to form a spot in a distant location using a set of distributed transmitters. In order to form a spot with high signal to noise ratio in a distant location, all elements of the distributed UWB transmitters (array of antennas) have to transmit the same form of UWB pulse. The coherent addition of the pulses can generate a strong signal with high SNR that can be used to remotely power a passive UWB tag from a long distance. Increasing the number of elements in the array of transmitters improves the spotforming in terms of peak amplitude of the spot, signal-to-noise-ratio (SNR), and range. FIG. 3 illustrates the concept of using UWB antenna arrays for forming a spot in a specific point in the far field of individual array elements.

As shown in FIG. 3, an array 50 of antennas (or antenna elements) 52 (five are shown but any number may be used) focuses energy on a focal point 54. A reflector or backplane 56 may be positioned behind the antenna array 50 to increase energy and range.

The parameters that can be used to reduce the spot size and form a localized high energy signal at a distant spot are pulse shape and distance between the antenna elements in the array (could be uniform or non-uniform separation). Various antenna array architectures for spot forming can be formed with localized spots. Designing an efficient spot in terms of peak amplitude, distance from the array, and sharpness of the spot can significantly improve the powering range of UWB passive tags. Since UWB pulses have high peak amplitudes, focusing allows high peak amplitudes to add constructively and overcome diode drop to power up efficiently. This makes remote powering effective and efficient.

Thus, the present invention provides a “two-way” ultra-wideband (RFID) system and method that results in an increased energy efficiency and a greater communications range of up to about 20 meter or more. Unlike high-power narrowband tags, the present system and method utilizes a plurality of short-duration, high-peak amplitude UWB (e.g., of up to about 1 KV) pulsing transmitters to remotely power (“activate”) the tags. The tag receiver uses an efficient, energy-scavenging, UWB-matched circuit to receive the sub-nanosecond UWB pulses to the tags. The directed pulses beneficially reflect off nearby objects and are detected by the passive UWB tags. Just a few microwatts of remote power is adequate to power up, i.e, activate, the tags, as disclosed herein, because low duty cycle UWB pulses contain much higher peak power than CW signals. The large instantaneous power in UWB pulses overcomes the diode drop associated with the rectifying diode of the tag rectifier, resulting in increased efficiency of energy extraction and, therefore, powering out to greater distances. Thereafter, an interrogator unit detects energy rebounded in a radar implementation from the one or more remotely powered-up tags. In particular, when a predetermined tag's power capacitor circuit charges up remotely (“remotely activated”) and upon receiving an interrogating code from an interrogator so as to awaken the predetermined tag, a unique response code based on a respective tag's configured logic circuit is initiated to drive the tag antenna into a sequence of switching transitions (a series of OPEN/CLOSE states) in response to the interrogating code. In other words, once the tag is powered up, it transmits its unique tag address or code by way of reflecting in-coming UWB radar pulses as determined from the encoded information induced on the tag antenna.

Accordingly, the present invention is directed to a long-range, Radio Frequency IDentification (RFID) signaling method and apparatus/system that capitalizes on UWB wireless technology to power up remote devices to enable data to be transmitted and received in short durational pulses (e.g., durations from about 100-picoseconds up to about 5 nanoseconds) across a wide range of the electromagnetic spectrum. In particular, the use of UWB and the configurations and methods herein enable remote powering of configured radio frequency (RF) tags at up to about 20 meters or more and enable the interrogation of such devices for inventory and tracking purposes.

### Specific Description

As briefly discussed above in the general description, such novel UWB configurations of the present invention provides passive RFID tags and a reader (e.g., an interrogator) that employs coded radar pulsed formats to identify, inventory, as well as track a variety of items, such as, but not limited to, computer hard drives, computer disks containing product specifications, prototype drawings, or personnel records. It is to be appreciated that by using such coded pulsed UWB formats and configurations described herein, the present invention can simultaneously interrogate (i.e., awaken) an unlimited number of configured tags at long ranges (up to about 20 meters) even if such tags are positioned in unfavorable cluttered or metallic environments, (e.g., in warehouses, retail stores, corporate offices, and/or military installations).

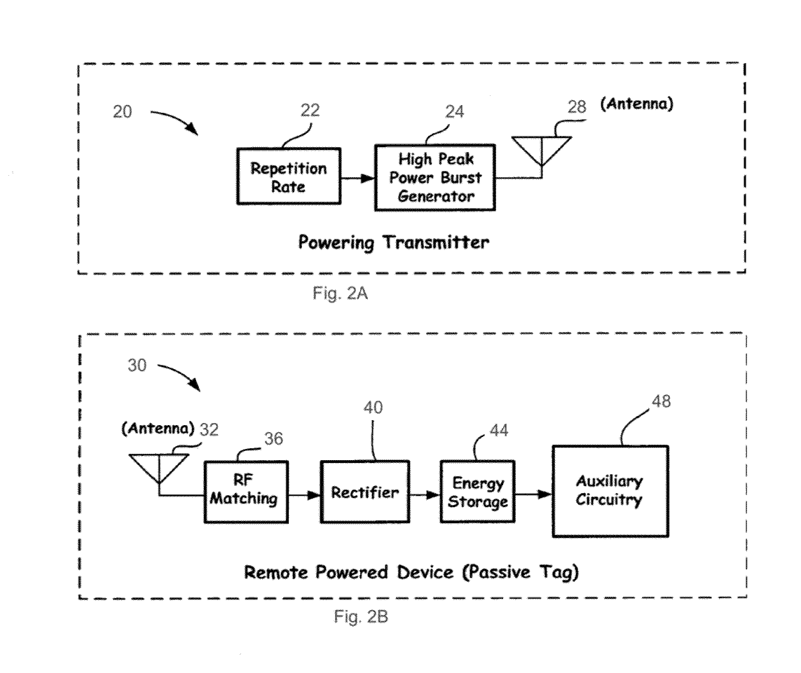

Turning now to the drawings, FIG. 2A and FIG. 2B respectively show basic schematic representations of components of a UWB powered RFID system of the present invention. In particular FIG. 2A generally shows an UWB powering transmitter 20, that minimally includes a repetition rate generator 22, a high peak power UWB burst generator 24, and a transmitter antenna 28.

FIG. 2B shows a remote powered device 30 (e.g., a passive UWB RFID tag), that includes a receiving antenna 32 configured to receive powering UWB pulses from powering transmitter 20 and additionally configured to direct received radar pulses from a predetermined UWB radar interrogator (not shown). In addition, RFID tag 30 also minimally includes RF matching circuitry 36, a rectifier 40, such as a single configured diode, an energy storage means 44, such as, for example, a capacitive element, and a configured auxiliary circuitry 48 that is powered up by the techniques and circuitry of the present invention, e.g., RF matching circuitry 36, rectifier 40, and energy storage means 44, but has no power source other than what power is extracted from one or more received UWB pulses.

Power transmitter 20 provides one or more high amplitude of up to about 1 KV, low duty cycle UWB pulses each having a pulse-width from about 100 ps up to about 5 ns, with low average power of down to about 5 mW, to be directed to remote tags (or other devices) 30, for the purpose of supplying power to such devices because of their respective passive configurations.

Accordingly, in the method of operation, an array of powering transmitter 20 is arranged to first send high amplitude, low duty cycle UWB pulses, as described above, to provide the necessary energy to activate one or more remote devices, e.g., passive tag 30. Each respective passive tag, such as tag 30, scavenges energy from the transmitted UWB RF pulses and the tag switches into a response mode as then arranged from auxiliary circuitry 28. Finally, coded-UWB radar, as described below, then interrogates the tag to awaken predetermined tags, such as tag 30 so as to obtain the tag's unique serial identification code.

### Battery-less Remote Charging

As stated above, the RFID system and method, as disclosed herein, provides increased energy efficiency and a greater communications range of up to about 20 meters. The present invention also beneficially utilizes a short-duration, high-peak amplitude UWB pulsing transmitter to remotely power the tags using one or more high amplitude UWB pulses of up to about 1 KV, having a low duty cycle, wherein each pulse is configured with a pulse-width from about 100 ps up to about 5 ns. Just a few microwatts of remote power of up to about 5 mW is adequate to power up (activate) the tags because such low duty cycle UWB pulses contain much higher peak power than CW signals. The large instantaneous power in UWB pulses overcomes the diode drop associated with the rectifying diode (i.e., rectifier 40 as shown in FIG. 2B), resulting in increased efficiency of energy extraction and, therefore, powering out to greater distances.

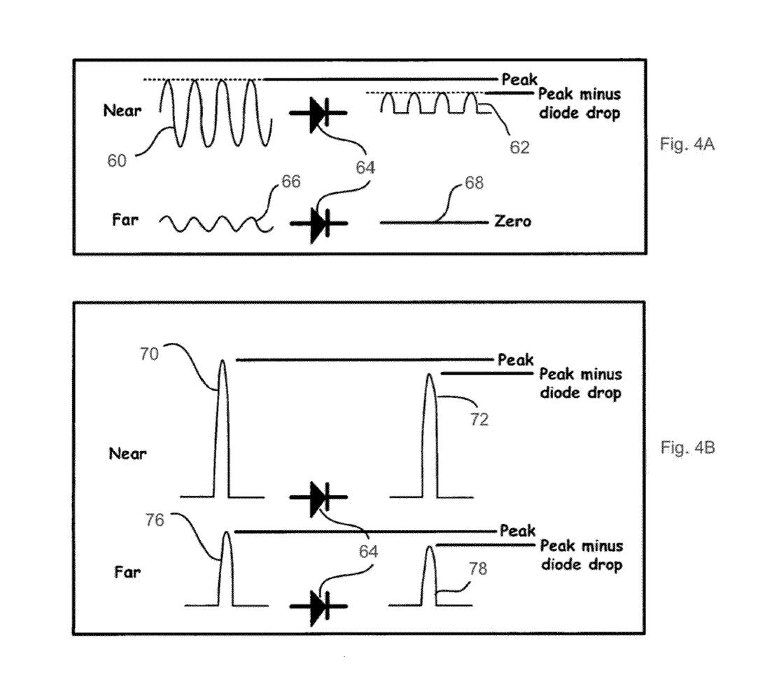

RF signals can remotely power electronic circuits from a remote distance. The remote powering distance is highly dependent on the voltage level at the storage capacitors after overcoming the diode drop in electronic circuits. Comparing UWB and narrowband signals with the same average power, one can see that UWB signals contain significant amount of residual voltage after overcoming the diode drop in a remote electronic circuit. This is due to their high peak power and low duty cycle that provides enough instantaneous power to compensate for the diode drop while still maintaining the low average power. FIGS. 4A, B compare the ability of narrowband and UWB signals for their remote powering capability.

FIG. 4A and FIG. 48 depict a comparison of power transfer efficiency between narrow band continuous wave (CW) powering signals, as shown in FIG. 4A, and Ultra-Wideband (UWB) powering signals, as shown in FIG. 4B. In particular, the top representation FIG. 4A shows that at near distances, i.e., up to about 3 feet, CW powering via transmitted CW signal 60 produces a positive cycle CW signal 62 after diode 64 of still sufficient amplitude because the peak power minus the power drop across a rectifying diode 64 may still power up remote passive devices of the present invention within the allotted distances. However at far distances, e.g., at distances of 10 to 20 meters, an attenuated CW powering signal 66 (i.e., far distances diminish the signal strength) can result in an insufficient signal 68 across rectifying diode 64 so that such a transmitted CW signal 66 is incapable of powering any passive tag device as disclosed herein.

Conversely, FIG. 4B illustrates that by using UWB pulsed signaling formats (near pulse 70 and far 76) of the present invention, there is still sufficient enough power even after rectification (near 72 or far 78) via a power diode 64, at either near or far configurations of up to about 20 meters to enable such near or remote devices to be in a powered up (i.e., activated) mode. FCC originally considered peak power in 2002, but in a 2005 addendum, they considered the average power.

It is to be appreciated that UWB RFID tags as disclosed herein, need only about a couple of microwatts of power from a transmitter/receiver to active its digital radar reflecting behavior. Thus the power available in the UWB tags of the present invention is not the limiting factor in meeting long-range tag interrogation capabilities, but it is overcoming FCC limitations on power transmission.

Continuous wave narrowband signals can power up electronic circuits in a short distance. For the same average power, UWB high power, low duty cycle signals contain enough energy to power up a device from a far distance. As shown in the above FIGS. 4A, B, after overcoming the diode drop (usually 0.7 volts), narrowband signals do not have enough power left to remotely power any electronics circuit from a far distance. However, for the same average power, UWB signals are capable of powering electronic circuits from a far distance even after compensating for the voltage used in diode drop.

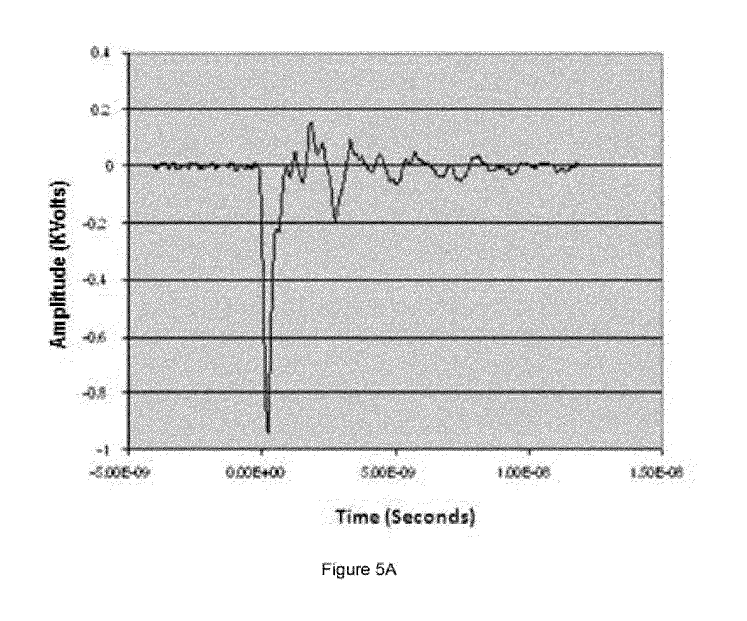

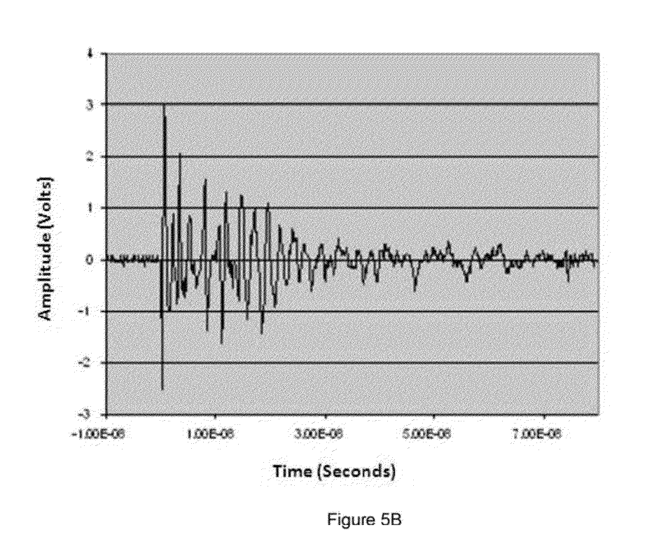

FIGS. 5A, B show an actual transmitted UWB signal and the actual voltage available in a circuit at a distance of 15 m. As shown, the transmitted UWB pulse for remote powering experiments has 1 KV peak-to-peak amplitude for the duration of only 12 nanoseconds. The received signal at 15 m distance has a peak amplitude of 3 V which translates to 180 mW of peak power. This experimental result shows that a passive UWB to can be remotely charged at a much longer distance with a reasonable duty cycle since only microwatts of average power is required to power up passive tags; (for minimum identification capability, tags with memory need more power). Antenna design plays an essential role in the remote powering range; high-gain, directional multi-element antennas provide remote powering capability at longer distances. Furthermore, changing the diodes in passive tags to Schottky diodes can increase the remote powering distance further. Schottky diodes have the advantage of low forward voltage drop across their terminals (approximately 0.15-0.45 V) compared to normal diodes that have a voltage drop of 0.7 to 1.7 V. The decreased voltage drop provides high efficiency in remote powering of tags and adds to the remote powering distance.

### Antenna Arrays and Beam Patterns

Properly spaced ultra-wideband antenna arrays can provide localized energy in both space and time. This technique is called “spotforming” and can be very effective in powering passive RFID tags from a long distance. The “array” is a spatially distributed set of “antennas”, where the geometrical arrangement of the antennas, and their excitation sequence result in a “multi-element array radiation pattern” which is different from the “single-element antenna radiation pattern”. Therefore, antenna arrays lead to a more robust and diverse signal source, as they employ multiple antennas in multiple configurations. As is known in the art, array beam patterns are affected by array aperture length and the number of elements in the array. Since UWB pulses have high bandwidth or short duration, multiple antennas with an array allow spot forming, a precise form of space-time localization and a generalization of beam forming.

### Tag Interrogation

Once the RFID tags are powered, as disclosed herein, UWB digital radar can be used to interrogate the UWB powered tag, i.e., to detect tag information. An UWB radar system would have an interrogator UWB radar unit to read one or more remote tag devices. The interrogator radar unit generally includes an UWB transmitter, one or more receivers, timing circuitry to synchronize outgoing data as directed by the transmitter and detected radar-reflected coded data, a transmitting antenna, and a receiving antenna that detects energy rebounded in a radar implementation from one or more remote tags. A power capacitor circuit charges up remotely (is “activated”), its configured logic circuit (generally a switch) drives a configured tag antenna into a unique sequence of switching transitions (a series of OPEN/CLOSE states), generated by an embedded unique tag address. An illustrative UWB radar unit is shown in U.S. Pat. No. 8,188,841, which is herein incorporated by reference.

In particular, once a tag is powered up using UWB pulsed formats as described above, a tag can transmit its unique tag address by way of its antenna operating as a radar-like reflector of received incident UWB pulsed codes upon being put in an awakened status. The tag thus behaves as a “Digital Radar reflector,” with the reflecting pattern defined by the switching timing code, i.e., unique tag address, as configured within each logic circuit.

The interrogating codes (i.e., incident UWB pulsed information to awaken predetermined tags) can be orthogonal codes, such as, but not limited to code division multiple access (CDMA) technology, Hermite function based orthogonal transmitted coded pulses and wavelet coded waveforms, or any of the orthogonal coding methods and/or transmitted reference (TR) modulation techniques disclosed and described in U.S. Pat. No. 7,194,019 titled “Multi-pulse multi-delay (MPMD) multiple access modulation for UWB” by Dowla et al., which is herein incorporated by reference in its entirety. For example, the transmitted and received pulses of the present invention can include chirp pulses (i.e., a frequency modulated signal) with different start and end frequencies with each user having its own unique pulse shape. Chirp pulses that do not overlap in frequency band and are theoretically uncorrelated with each other (i.e., are orthogonal) can thereby be separated using techniques, such as TR modulation and autocorrelation techniques.

The receivers can be configured to demodulate the reflected pulses from a tag for multi-tag detection purposes, as further discussed below, if different frequencies, i.e., codes, are used to detect each tag and are more often coupled to processing means, such as, for example, computers for correlation, range determination, and for distinguishing said modulated interrogation ultra-wideband signals from said activated one or more tags. Such receivers can be configured with architectures known and understood by those skilled in the art, such as, but not limited to, high sensitivity, high gain, and high selectivity devices, wherein the high sensitivity is achieved through a high level of signal integration and high detection efficiency. Additional similar architectures for use as receivers are disclosed in U.S. Pat. No. 7,305,052, titled “UWB Communication and Receiver Feedback Loop” by Spiridon et al., which is herein incorporated by reference in its entirety. Such architectures combine a feedback loop method and system, orthogonal pulse shape coding, to conventional TR receivers to suppress narrow band interferers (NBI) and additive white Gaussian noise (AWGN), improve bit error rate (BER) performance, reduce MAI, and increase channel capacity.

It should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An ultra-wideband (UWB) method, comprising:
providing one or more passive electronic devices;
remotely powering each device by providing a plurality of remotely located ultra-wideband transmitters;
generating low duty cycle high-peak power ultra-wideband pulses from each transmitter;
positioning multiple of the plurality of transmitters to transmit pulses to each device, the pulses from the multiple transmitters arriving at each device cumulatively combining to produce a power level to activate the device; and
interrogating each activated device.

2. The method of claim 1, wherein generating low duty cycle high-peak power ultra-wideband pulses comprises generating ultra-wideband pulses having pulse widths of less than about 5 ns.

3. The method of claim 2, wherein generating low duty cycle high-peak power ultra-wideband pulses comprises generating pulses having peak amplitudes of up to about 1 KV.

4. The method of claim 1, wherein remotely powering each device comprises powering each device at ranges of up to about 20 meters.

5. The method of claim 1, further comprising arranging the plurality of ultra-wideband transmitters in multiple arrays of transmitters

6. The method of claim 5, further comprising configuring each array of transmitters to spotform the pulses at a localized focal region at which a device is located.

7. The method of claim 6, further comprising positioning a reflector adjacent to an array of transmitters.

8. The method of claim 1, further comprising selecting the devices from RFID tags and sensors.

9. The method of claim 1, wherein said one or more devices comprise a rectifying diode as part of a rectifying circuitry.

10. The method of claim 9, wherein the plurality of transmitters are configured and positioned so that the cumulative power level produced at each device sufficiently exceeds the voltage drop of rectifying diode to activate the device.

11. An ultra-wideband (UWB) remotely powered system, comprising:
one or more passive electronic devices;
a plurality of remotely located ultra-wideband transmitters, each configured to generate low duty cycle high-peak power ultra-wideband pulses, multiple of the plurality of transmitters being, positioned to transmit pulses to each device, the pulses from the multiple transmitters arriving at each device cumulatively combining to produce a power level to activate the device; and
a reader positioned to interrogate each activated device.

12. The system of claim 11, wherein the electronic devices are RFID tags or sensors.

13. The system of claim 11, wherein the plurality of ultra-wideband transmitters are arranged in multiple arrays of transmitters.

14. The system of claim 13, wherein each array of transmitters are configured to spotform the pulses at a localized focal region at which a device is located.

15. The system of claim 14, further comprising a reflector positioned adjacent to an array of transmitters.

16. The system of claim 11, wherein the ultra-wideband transmitters are configured to produce pulses having peak amplitudes of up to about 1 KV.

17. The system of claim 11, wherein the ultra-wideband transmitters are configured to produce pulses of less than about 5 ns.

18. The system of claim 11, wherein said one or more devices comprise a rectifying diode as part of a rectifying circuitry.

19. The system of claim 18, wherein the plurality of transmitters are configured and positioned so that the cumulative power level produced at each device sufficiently exceeds the voltage drop of the rectifying diode to activate the device.

20. The system of claim 11, wherein the plurality of transmitters are configured to activate the devices at a range of up to about 20 meters.
